(19) United States
(12) Patent Application Publication
(10) Pub. No.: US 2005/0162694 A1
(43) Pub. Date: Jul. 28, 2005

(54) Printer control device

(75) Inventors: Hirotaka Chiba, Kawasaki (JP); Tsugio Noda, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/084,111

(22) Filed: Mar. 21, 2005

Related U.S. Application Data
(63) Continuation of application No. PCT/JP03/04782, filed on Apr. 15, 2003.

(51) Int. Cl. G06F 15/00

(52) U.S. Cl. 358/1.15

(57) ABSTRACT

Compressed print data from a host PC is transferred to the data receiving unit, compressed print data transfer unit and compressed print data storage unit of a printer controller unit, and is transferred to a bitmap data storage unit after being restored to a bitmap by a data restoration/transfer unit. Then, the decompressed print data is output to a printer engine by a bitmap data transfer unit as video signals. The data storage capacity management unit optimally re-distributes storage capacity between two storage areas of the compressed print data storage unit and bitmap data storage unit, according to printing status signals, such as resolution, paper size, warm-up status of an engine, previous frequency of use, transfer speed and the like.

### CROSS-REFERENCE TO RELATED APPLICATION

This application is a continuation of an International Application No. PCT/JP03/04782, which was filed on Apr. 15, 2003.

### BACKGROUND OF THE INVENTION

1. Field of the Invention

The present invention relates to a printer control device for a printer without its own fonts to receive compressed print data from host equipment without the necessity to expand the memory capacity and print efficiently without wasting memory capacity.

2. Description of the Related Art

Although many conventional printers have their own fonts, recently printers without their own fonts, for reasons, such as the increase in graphic print content, the high cost of the generation of fonts, and the like, for receiving bitmap data (video signals) from host equipment, such as personal computers and the like as print data, instead of character codes and printing by simply decompressing the compressed bitmap data are known (for example, see Patent Reference 1).

As recently not only characters but also images are printed the resolution of such printers has improved, and the volume of bitmap data in a given print job has increased dramatically. As the amount of bitmap data increases, the amount of data transferred between host equipment and printer increases, increasing the time required to transfer print data and also increasing print processing time. Especially where network printers are popular, data transfer takes a long time increasing print time, which is a serious problem.

In order to shorten this data transfer time, that is, to transfer the same amount of bitmap data in a shorter time, the bitmap data is compressed. A bitmap data compression method for compressing it into print data in units of bytes and reducing the process load on the host computer and printer and a device thereof are known (for example, see Patent Reference 2).

Upon receipt of such compressed print data, a printer restores the compressed print data to the bitmap data, decompresses the restored bitmap data in bitmap data memory and transfers this decompressed bitmap data to a printer engine unit to print.

In this case, since the data transfer time has been improved, print job time should also be improved. However, wait time occurs at the host side and the effect of the shortened data transfer time is halved. Therefore, print time is improved by preparing a buffer for the received compressed print data and a buffer for decompressing the restored bitmap data.

FIG. 1 shows the configuration of the printer controller unit of a conventional printer for printing such received compressed print data at high speed.

In FIG. 1, a printer controller unit 1 comprises a data receiving unit 2, a central control unit 3 and a data storage unit 4. The printer controller unit 1 receives compressed print data from a personal computer, which is higher-order host equipment, (hereinafter called a “host PC”), for example, via a local network 6 or the like and outputs this received compressed print data to a printer engine 8 via bus 7 after the central control unit 3 converts it into video signals.

The central control unit 3 of the printer controller unit 1 performs a predetermined task by a predetermined program module. In the example shown in FIG. 1, the central control unit 3 comprises at least three task processors of a compressed print data transfer unit 9, a data restoration/transfer unit 10 and a bitmap data transfer unit 11.

The data storage unit 4 of the printer controller unit 1 is a memory device, and comprises two storage areas of a compressed print data storage unit 12 and a bitmap data storage unit 13.

The printer engine 8, not shown in FIG. 1, comprises a control circuit including a central processing unit (CPU), and controls, for example, the rotation drive of a print drum, paper feeding rollers, etc., the drive of a light-emitting exposure head, the heating drive of a fixing unit and the like.

A printer connected to a personal computer 5 or the like, and which usually prints by the following process.

Firstly, print data generated by the personal computer 5 is compressed by the above-mentioned method and is transmitted to the printer controller unit 1 via the local network 6 as compressed print data, and the printer controller unit 1 receives the transmitted compressed print data via the data receiving unit 2. This received compressed print data is transferred to the compressed print data storage unit 12 of the data storage unit 4 via the compressed print data transfer unit 9 of the central control unit 3 and is temporarily stored in the compressed print data storage unit 12.

Then, the central control unit 3 of the printer controller unit 1 accesses the compressed print data storage unit 12 in which the compressed print data is stored, the data restoration/transfer unit 10 restores the read compressed print data to the bitmap data and decompresses this restored bitmap data for one page in the bitmap data storage unit 13 of the data storage unit 4.

Then, the bitmap data for one page developed in this bitmap data storage unit 13 is transferred to the printer engine 8 by the bitmap data transfer unit 11 of the central control unit 3 and is printed by the printer engine 8.

However, generally a printer cannot decompress this received data without any management processes while receiving it and cannot print this decompressed data without any control processes. After a printer starts and the print drum starts to rotate, the output of video signals cannot be stopped until the printing of one page is completed. Therefore, as described above, the bitmap data storage unit 13 for enabling the restored bitmap data to stand by for printing must be provided, and when the decompression of the bitmap data for one page is completed, it must be input to the printer engine 8 as print data. Then, the print drum is rotated at a specific speed, and video signals are output to the exposure head. After sequentially performing its exposure, development, transfer and fixing, the video signals are printed.

However, print data is simultaneously received, and cannot be stopped. Therefore, as described above, the compressed print data storage unit 12 is provided to temporarily store compressed data.

Such a memory device with too much capacity is very expensive and from the viewpoint of printer control as small a memory capacity as possible is preferred. For these reasons, a memory area for at most two pages is allocated in advance for bitmap data. The area for the first page is used to store data to be input to the printer engine 8, and the area for the second page is used as a buffer for expanding compressed print data into bitmap data. Thus, data can be processed in print units of one page.

The remaining storage capacity of the entire memory area is allocated for the temporary storage of compressed print data and is used to receive compressed print data being restored/decompressed to bitmap data for printing.

However, especially where a printing device is designed to be used as office automation equipment (OA), a variety of printing parameters, such as print resolution, paper size, data receiving speed and the like, are in many cases configured for maximum printing performance in order to manage a variety of user requirements. For example, in many cases, print resolutions of up to 1200 dots per inch (dpi) are possible, instead of the default 300 dots per 2.54 cm. With respect to paper size, A3 can be handled, instead of the conventional B5, and data reception speeds of 300 K bytes/second or more can be coped with, instead of the usual 100 K bytes/second or less.

However, recently, although many office documents printed by a printing device are A4, B5 paper is often still used. As to the frequency of printing of data types, characters are printed overwhelmingly more than images. Although in the case of images, higher resolution is required, in the case of text, in many cases, even 300 dots can be used without any trouble.

The above-mentioned conventional printer has two problems.

The first problem is that since the storage capacities of both the compressed print data storage unit and bitmap data storage unit are fixed at predetermined values, based on the memory installed in the printing device, so that storage capacity can be easily managed and printer control can be easily achieved by a central control unit, for example, only half of the memory capacity for A3 paper, which is the maximum page size, is used when data is printed on A4 paper, using the set storage capacity of each of compressed print data and bitmap data. In the case of B5 paper, the used memory capacity decreases, and the remaining memory capacity is wasted, which is not economical.

The second problem is that when a resolution of 300 dpi is designated in order to improve the printing speed in the case of characters, only a quarter of the memory capacity for 1,200 dpi, which is the maximum printing resolution, is used. In this case too, not only is expensive memory capacity wasted, but the set maximum printing performance cannot be utilized, which is not economical.

It is an object of the present invention to provide a printer control device capable of managing memory allocation in such a way that the storage capacity of each storage unit can be efficiently used for each segment of print target data and printing can be executed using the maximum printing performance of a printing device, in order to solve the above-mentioned problems.

Patent Reference 1:

Japanese Patent Application No. H5 (1993)-270080

Patent Reference 2:

Japanese Patent No. 3278298

### SUMMARY OF THE INVENTION

The printer control device of the present invention comprises a compressed print data receiving unit for receiving compressed print data, a compressed print data storage unit for storing the received compressed print data in a compressed print data storage area in units of pages, a bitmap data storage unit for restoring the compressed print data stored in the compressed print data storage unit to bitmap data in units of pages and storing the restored bitmap data in a bitmap data storage area and a storage capacity management unit for modifying the distribution ratio of storage capacity between the compressed print data storage unit and the bitmap data storage unit, according to the printing state of a printing device.

In the preferred embodiment, the storage capacity management unit modifies the distribution ratio of storage capacity between the compressed print data storage unit and the bitmap data storage unit, according to print resolution and paper size of a print target of the bitmap data restored in units of pages.

In another preferred embodiment, the storage capacity management unit modifies the distribution ratio of storage capacity between the compressed print data storage unit and the bitmap data storage unit, according to the determination result of a warm-up status determination unit for managing the warm-up status of the printing device.

Furthermore, in another preferred embodiment, the storage capacity management unit modifies in advance the distribution ratio of storage capacity between the compressed print data storage unit and the bitmap data storage unit, according to the frequency of each of the print resolution and paper size of print targets previously printed by the printing device. Alternatively, for example, as set forth in claim 5, the storage capacity management unit modifies in advance the distribution ratio of storage capacity between the compressed print data storage unit and the bitmap data storage unit, according to the receiving speed of print data previously printed by the printing device.

As described above, since according to the present invention, the storage capacity of each of the compressed print data storage unit and bitmap data storage unit in a printing device can be dynamically modified according to the printing status, and each data storage area can be managed so as to be efficiently used for each segment of print target data, printing can be executed using the maximum printing performance of the printing device. Accordingly, print efficiency can be improved.

Furthermore, since the lower the resolution is or the smaller the paper size is, the higher the receiving capacity of compressed print data is, a plurality of pages can be received in advance even when the amount of compressed print data of each page to print increases and a printing process can be continuously performed using the received compressed print data by expanding restored bitmap data, and thus printing performance can also be improved. Thus, since an increased amount of compressed print data can be stored even when the receiving speed of a printing device is low, there is no transmission wait at the host equipment and the congestion of network transmission lines can be reduced. Accordingly, the efficiency in use of network transmission lines can be improved.

Furthermore, since an increased amount of compressed print data can be received and accumulated in the compressed print data storage unit during warm-up by modifying the distribution ratio of storage capacity between the compressed print data storage unit and bitmap data storage unit at the time of warm-up, the compressed print data of the compressed print data storage unit can be printed even when the transfer performance of a printing device is poor. Thus, printing speed can be improved.

Furthermore, since storage capacity is distributed between the compressed print data storage unit and bitmap data storage unit at the start of the print job in such a way that optimal conditions of use can be obtained, based on the previously used conditions of a user, the user can always use a printing device with his/her optimal conditions. Thus, printing efficiency can be improved.

Furthermore, since if the transfer performance of a network or host equipment is good, the storage capacity of the compressed print data storage unit can be reduced in correspondence with the transfer performance, and the occurrence of decompression wait can be prevented by increasing the storage capacity of the bitmap data storage unit to two pages or more, printing performance can be improved.

### BRIEF DESCRIPTION OF THE DRAWINGS

FIG. 1 shows the configuration of the printer controller unit of a conventional high-speed printer using compressed print data.

FIG. 2 shows the configuration of the printer controller unit of a printer in the first preferred embodiment.

FIG. 3A shows the configuration of the printer controller unit of a printer in the second preferred embodiment and FIG. 3B is a table showing the relationship between resolution, paper size and the capacity of a storage unit.

FIG. 4 is a flowchart showing the printing process of the printer controller in the second preferred embodiment.

FIG. 5 shows the configuration of the printer controller of the printer in the third preferred embodiment.

FIG. 6 is a flowchart showing the printing process of the printer controller in the third preferred embodiment.

FIG. 7A shows the configuration of the printer controller unit of a printer in the fourth preferred embodiment and FIG. 7B shows an example of the data of the printing status storage table.

FIG. 8 is a flowchart showing the printing process of the printer controller in the fourth preferred embodiment.

FIG. 9A shows the configuration of the printer controller unit of a printer in the fifth preferred embodiment and FIG. 9B shows an example of the data of the printing speed storage table.

FIG. 10 is a flowchart showing the printing process of the printer controller in the fifth preferred embodiment.

### EXPLANATION OF THE CODES

1 Printer controller unit
2 Data receiving unit
3 Central control unit
4 Data storage unit
5 PC host
6 Local network
7 Bus
8 Printer engine
9 Compressed print data transfer unit
10 Data restoration/transfer unit
11 Bitmap data transfer unit
12 Compressed print data storage unit
13 Bitmap data storage unit
15 Printer controller unit
16 Data receiving unit
17 Central control unit
18 Data storage unit
21 Compressed print data transfer unit
22 Data restoration/transfer unit
23 Bitmap data transfer unit
24 Data storage capacity management unit
25 Compressed print data storage unit
26 Bitmap data storage unit
27 Personal computer
28 Local network
29 Printer engine
31, 32 Bus
33 Resolution/paper size determination unit
34 Management table showing the relationship between resolution, paper size and the capacity of a storage unit
35 Warm-up status determination unit
36 Bus
37 Resolution/paper size accumulation unit
38 Printing status storage table
39 Transfer speed storage unit
41 Transfer speed storage table

### DESCRIPTION OF THE PREFERRED EMBODIMENTS

The preferred embodiments of the present invention are described below with reference to the drawings.

### The First Preferred Embodiment

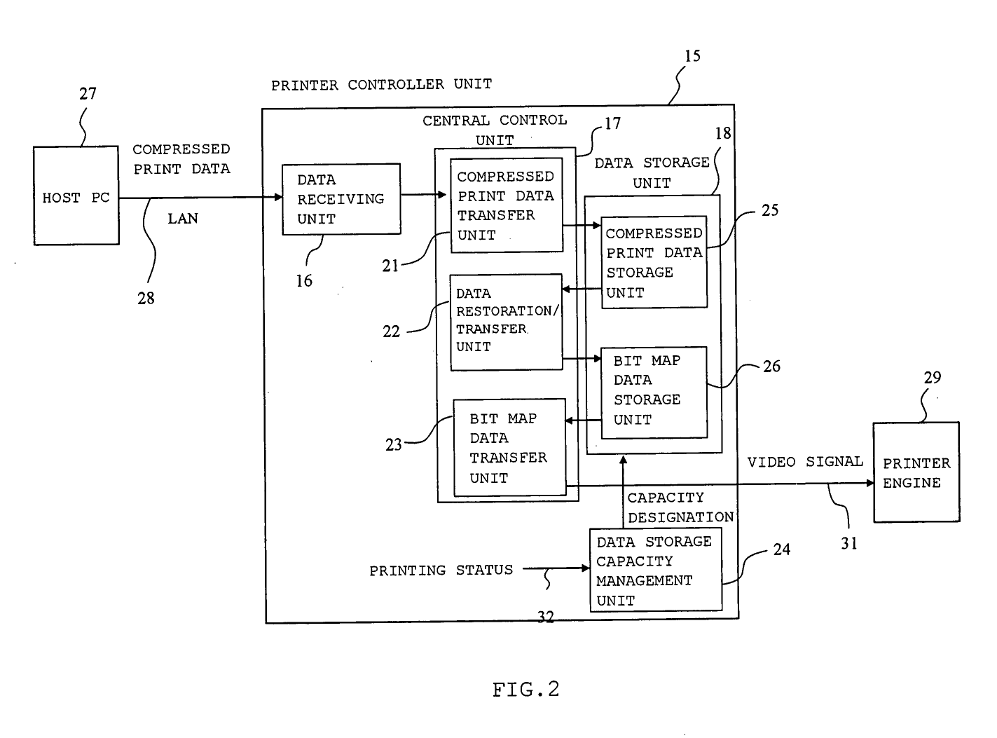

FIG. 2 shows the configuration of the printer controller unit of a printer in the first preferred embodiment. The configuration of a printer controller unit 15 as a printer control device shown in FIG. 2 shows the basic configuration of the present invention. The printer controller unit 15 comprises a data receiving unit 16, a central control unit 17 and a data storage unit 18.

The central control unit 17 comprises at least four task processing units of a compressed print data transfer unit 21, a data restoration/transfer unit 22, a bitmap data transfer unit 23 and a data storage capacity management unit 24 (although in FIG. 2, it is shown externally to the central control unit 17 for the purpose of the description which follows, it is actually the task processing unit of the central control unit 17).

The data storage unit 18 is a memory device, and comprises two storage areas of a compressed print data storage unit 25 and a bitmap data storage unit 26.

To the data receiving unit 16, compressed print data is input from a host PC 27, for example, via a local network 28, and from a bitmap data transfer unit 23, video signals are output to a printer engine 29 via a bus 31.

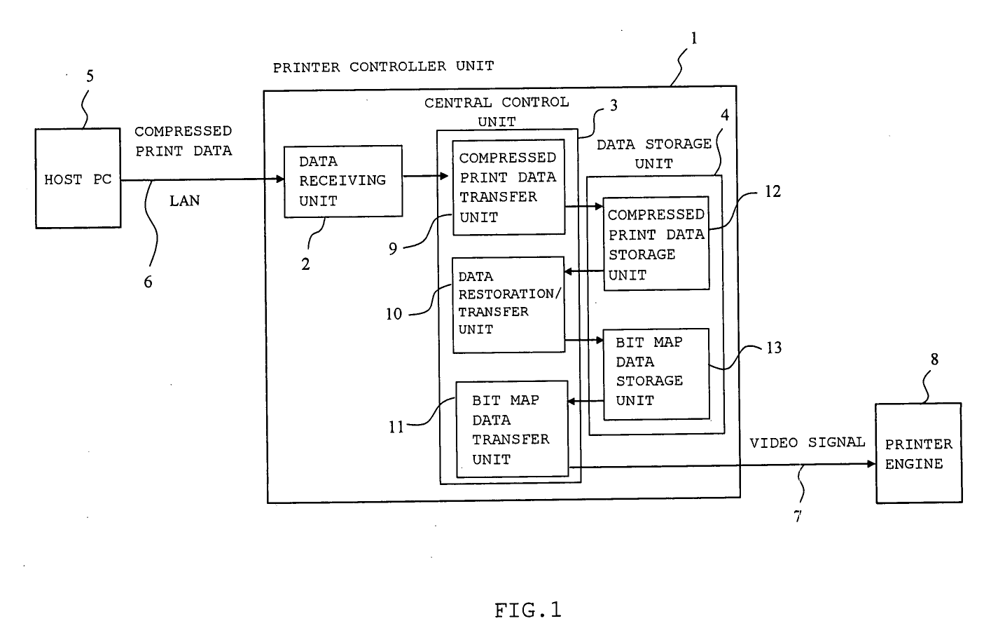

The configuration and function of the data receiving unit 16, central control unit 17, data storage unit 18, compressed print data transfer unit 21, data restoration/transfer unit 22 and bitmap data transfer unit 23 of the printer controller unit 15 of the printer, and the printer engine 29 shown in FIG. 2 are the same as those of the data receiving unit 2, central control unit 3, data storage unit 4, compressed print data transfer unit 9, data restoration/transfer unit 10, and bitmap data transfer unit 11 of the printer controller unit 1, and the printer engine 8, respectively, shown in FIG. 1.

In this preferred embodiment, a data storage capacity management unit 24 is provided. This data storage capacity management unit 24 optimally distributes storage capacity between the two storage areas of the compressed print data storage unit 25 and the bitmap data storage unit 26 of the data storage unit 18, based on a signal indicating a variety of printing statuses input via a bus 32.

In other words, the storage capacity of each of the compressed print data storage unit 15 and the bitmap data storage unit 26 in this preferred embodiment can be changed by the data storage capacity management unit 24.

AS described above, since the capacity of each storage area in a printing device can be managed so that each data storage area can be efficiently used for each segment of print target data by dynamically modifying it according to a printing status, printing can be executed using the maximum printing performance of the printing device.

### The Second Preferred Embodiment

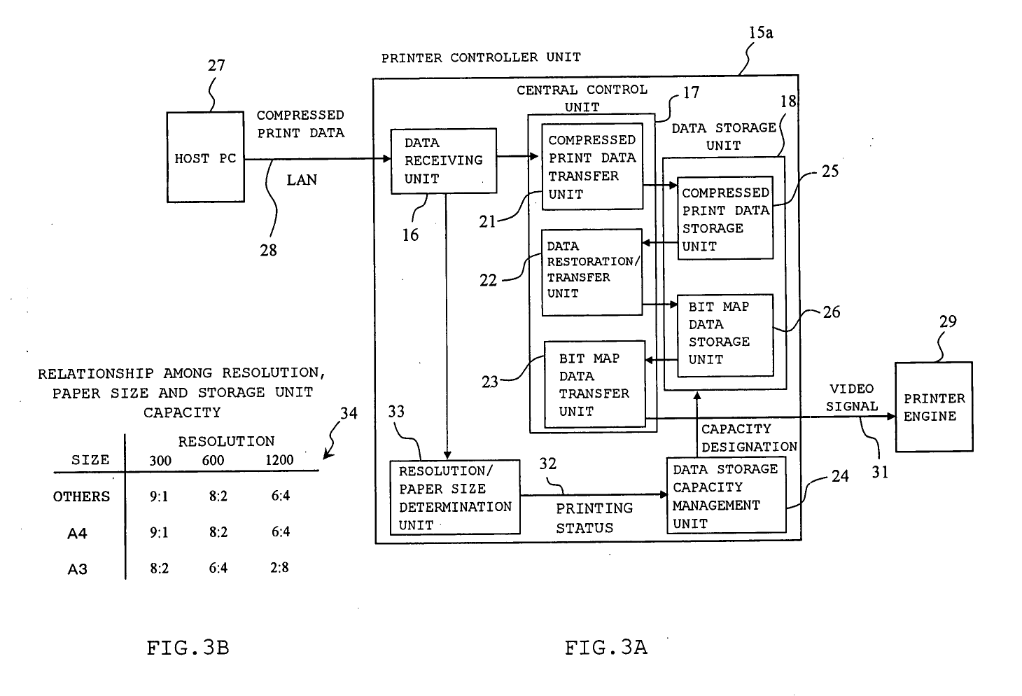

FIG. 3A shows the configuration of the printer controller unit of a printer in the second preferred embodiment and FIG. 3B is a table showing the relationship between resolution, paper size and the capacity of a storage unit.

As shown in FIG. 3A, in this preferred embodiment, a printer controller unit 15a comprises a resolution/paper size determination unit 33, and printing status information is output from this resolution/paper size determination unit 33 to the data storage capacity management unit 24 via the bus 32.

The resolution/paper size determination unit 33 is provided with a management table 34 in advance indicating the relationship between resolution, paper size and the required memory distribution of the storage unit, shown in FIG. 3B. As shown in FIG. 3B, in the table 34, its columns indicate the resolution, such as “300 (dpi)”, “600” and “1,200”, and its rows indicate the paper size, such as “miscellaneous”, “A4” and “A3”.

A numeric value corresponding to a resolution and paper size in the table, for example, takes the value of “2:8” if the resolution is 1,200 dots and the paper size is A3. This indicates the ratio of storage capacity between the compressed print data and bitmap data of the entire storage capacity of the data storage unit 18.

With respect to the distribution of storage capacity, firstly, storage capacity for two pages is allocated with priority to bitmap data. In the example shown in FIG. 3B, if the resolution and paper size are 1,200 dots and A3, respectively, the storage capacity is distributed with the ratio “2:8”, specifically, 8/10 of the entire storage capacity is first allocated as two pages for bitmap data, and the remaining 2/10 is allocated to compressed print data.

Since the resolution of 1,200 dots and the paper size A3 both are the maximum values of the respective parameters, and thus represent the maximum performance of this printing device, this distribution ratio “2:8” of storage capacity is the default value of this printing device.

Furthermore, according to the table 34, the required capacity of the bitmap data in the case of 600 dots is a half of that in the case of 1,200 dots. Therefore, in the case of 600 dots, the distribution ratio of storage capacity becomes “6:4”. In this case, 4/10 of the entire storage capacity is first allocated to bitmap data, and the remaining 6/10 is allocated to compressed print data. If in this case of 600 dots, the paper size is A4, the capacity of the bitmap data becomes a half of that in the case of A3. In such a case, the distribution ratio of storage capacity becomes “8:2”. Thus 2/10 of the entire storage capacity is first allocated to bit map data, and the remaining 8/10 is allocated to compressed print data.

The paper size represented by “Miscellaneous” in the table 34 shown in FIG. 3B includes B5 and A5, which are smaller than A4, and a post card respectively. “Miscellaneous” can also be classified into “B5”, “A5”, “post card” and the like, as described above, and the corresponding storage capacity distribution ratios can also be generated in advance.

In place of a table, numeric values similar to those of the table 34 can also be calculated, at the request of the resolution/paper size determination unit 33.

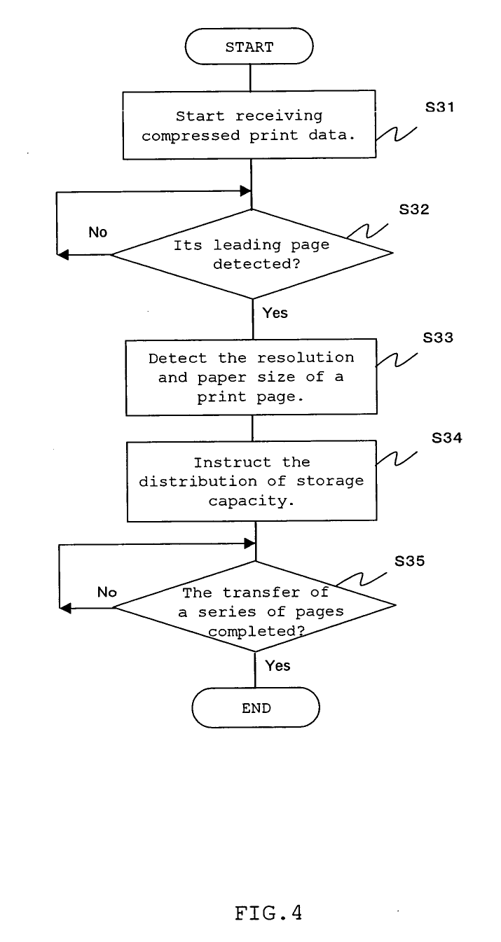

FIG. 4 is a flowchart showing the printing process of the central control unit 17 of the printer controller 15a in the second preferred embodiment. In FIG. 4, firstly, the central control unit 17 starts receiving compressed print data from the host PC 27 (S₃₁).

In this process compressed print data is transmitted by the host PC 27, and one page or more of this data is received by the data receiving unit 16 of the printer controller 15 via the local network 28 as one printing task under the same printing conditions.

The data receiving unit 16 of the central control unit 17, monitors the compressed print data being received by the compressed print data transfer unit 21, and determines whether the leading page of the received compressed print data is detected (S32).

If the leading page is detected (Yes in S32), the resolution and paper size of the print data is detected (S33).

In this process, the leading page of the compressed print data always includes information specifying the print resolution and paper size of a print target. The central control unit 17 not only transfers the compressed print data to the compressed print data storage unit 25 via the compressed print data transfer unit 21, but also transfers the header information of the leading page of the print data to the resolution/paper size determination unit 33.

The resolution/paper size determination unit 33 detects information about the print resolution and paper size, according to the header information of the leading page of the print data obtained from the compressed print data transfer unit 21. Then, the resolution/paper size determination unit 33 determines the print resolution and paper size of the print target according to this information and notifies the data storage capacity management unit 24 of this determination result as print status information.

Upon receipt of the information about its print resolution and paper size as print status information, the data storage capacity management unit 24 compares the detected resolution and paper size with their default values, based on the respective data of the management table 34 for resolution, paper size and the capacity of a storage unit. If the detected resolution and paper size differ from their default values of 1,200 dots and A3, which is the maximum printing performance of this printing device, the storage capacity of each of the compressed print data storage unit 26 and bitmap data storage unit 26 of the data storage unit 18 is modified according to the ratio of storage capacities indicated by the data of the management table 34 (S34).

In this process, the resolution/paper size determination unit 33 obtains storage capacity for two pages required by the bitmap data storage unit 26, according to print status information and allocates the storage capacity for two pages to the bitmap data storage unit 26. Then, the resolution/paper size determination unit 33 allocates the remaining storage capacity of the entire storage capacity of the data storage unit 18 as the storage area of the compressed print data storage unit 25.

The central control unit 17 determined whether a series of pages transfers to the printer engine 29 is completed (S35). In this process, it is determined whether the compressed print data storage unit 25 is empty and also whether the bitmap data storage unit 26 is empty.

If a series of page transfers is not completed yet (No in S35), the transfer of bitmap data (video signals) to the printer engine 29 is continued until completion. If this transfer is completed (Yes in S35), the printing process is terminated.

Thus, for example, if the maximum printing performance of this printing device is 1,200 dots and A3, the storage capacity for compressed print data is 2/10 of the entire data storage unit 18. If for example, data is printed on A4 paper with the same resolution of 1,200 dots, the storage capacity for compressed print data will become 6/10 of the entire data storage unit 18. Furthermore, if data is printed on A4 paper with the resolution of 300 dots, it will become 9/10 of it. Thus, the effective storage capacity for compressed print data increases.

As described above, the lower the resolution is or the smaller the paper size is the higher the effective receiving capacity of compressed print data. Therefore, even if the amount of compressed print data of each print page increases, a plurality of pages can be received in advance, and accordingly, the printing process can be continuously performed using received compressed print data by decompressing restored bitmap data. Therefore, printing performance can be improved.

Furthermore, since compressed print data can be accumulated even when the receiving speed of a printing device is low, there is no transmission wait at the host PC 27, and accordingly, congestion of transmission lines can be reduced.

### The Third Preferred Embodiment

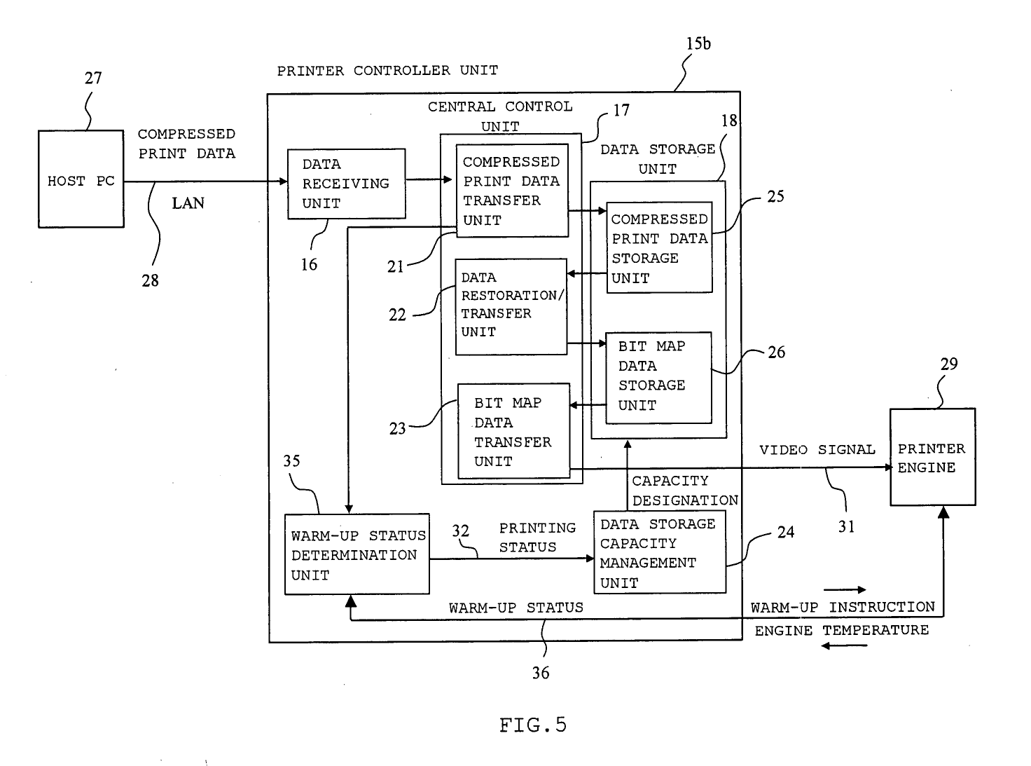

FIG. 5 shows the configuration of the printer controller of the printer in the third preferred embodiment. In FIG. 5, the same reference numerals as those of FIG. 2 are attached to components that are also shown in FIG. 2.

As shown in FIG. 5, in this preferred embodiment, a printer controller 15b comprises a warm-up status determination unit 35 instead of the resolution/paper size determination unit 33 shown in FIG. 3. This warm-up status determination unit 35 outputs a warm-up signal to the printer engine 29 via a bus 36 to start warm-up for print execution, and then receives engine temperature data (temperature of the fixing drum) from the printer engine 29 via the same bus 36.

The warm-up status determination unit 35 outputs printing status information and warm-up starting information, input from the data receiving unit 16, to the data storage capacity management unit 24 via the bus 32, and also monitors whether the engine temperature received from the printer engine 29 reaches a predetermined operating temperature. When it reaches the predetermined operating temperature, the warm-up status determination unit 35 outputs warm-up completion information to the data storage capacity management unit 24.

Generally, during idletime, a printing device is maintained below the operating temperature by disconnecting the heater of the fixing unit of a printer engine or putting it into a power-saving mode to reduce the power consumption of the entire device. When the print device starts to receive data, the heater current is turned on or is increased and warm-up is conducted until the fixing drum reaches the predetermined operating temperature. After warm-up is completed, the printing process starts.

During warm-up, no printing process is performed. Therefore, even if storage capacity for two pages is distributed to the bitmap data storage unit 26, data decompression cannot be performed after bitmap data for two pages has been decompressed.

Therefore, during warm-up, data capacity for only one page is distributed to the bitmap data storage unit 26, and the remainder is distributed to the compressed print data storage unit 25 and compressed print data is received and accumulated. After the completion of warm-up, the storage capacity of the bitmap data storage unit 26 is increased from one page to two pages as the printing process proceeds. When the storage capacity of the bitmap data storage unit 26 is increased, no compressed print data is received.

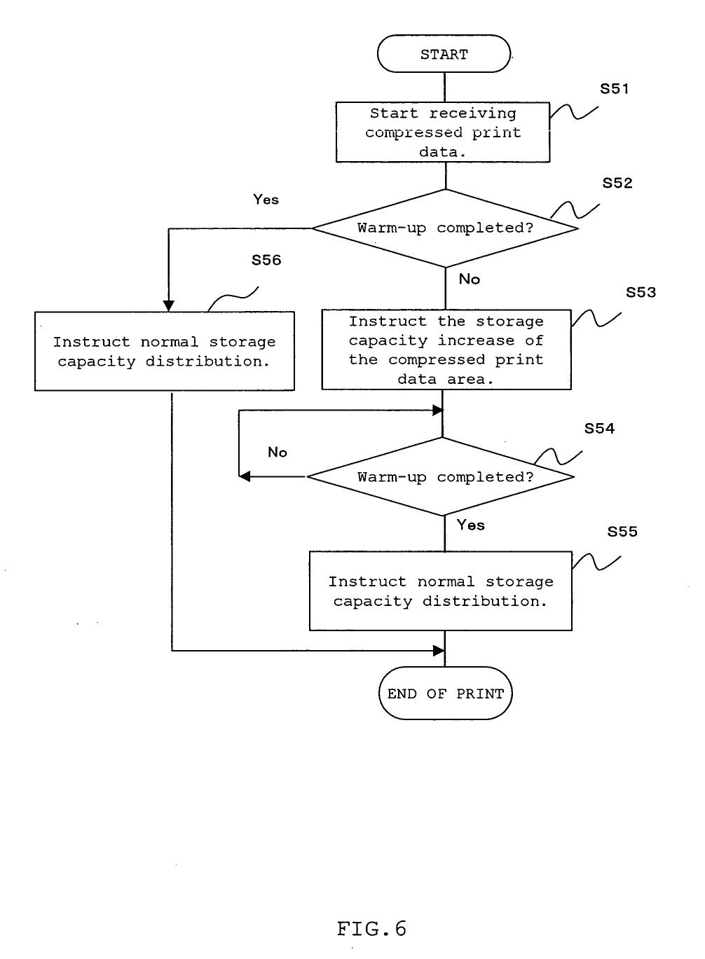

FIG. 6 is a flowchart showing the printing process of the central control unit 17 of the printer controller 15b in the third preferred embodiment.

In FIG. 6, firstly the central control unit 17 starts receiving compressed print data from the host PC 27 (S51). This process is the same as that of S31 shown in FIG. 4.

Then, the central control unit 17 determines whether the warm-up of the printer engine 29 is completed focusing on the fixing drum (S52). If the warm-up is not completed yet (No in S52), increase of the storage capacity in the compressed print data area is requested (S53).

In this process, since the resolution and paper size are specified by the print information by the detection of the leading page, not shown in FIG. 6, the data storage capacity management unit 24 calculates and allocates a bitmap data area for one page based on the resolution and paper size specified in the printing information and the warm-up starting information from the warm-up status determination unit 35. Then, the data storage capacity management unit 24 allocates all the remaining capacity excluding the bitmap data area for one page as an area for compressed print data, and instructs the data storage unit 18 to increase the storage capacity of the compressed print data storage unit 25.

Then, the central control unit 17 determines again whether the warm-up of the printer engine 29 is completed (S54), and continues to monitor it until the warm-up is completed (No in S54). If it is determined that the warm-up is completed (Yes in S54), the central control unit 17 instructs the data storage unit 18 to distribute storage capacity normally as specified in advance based on the print status (S55).

Then, the same process as in S35 shown in FIG. 4 is performed, not shown in FIG. 6, and the printing process is terminated. If the temperature of the fixing drum reaches its operating temperature as when a printing device is continuously used or is not in power-saving mode, when it is determined whether warm-up has completed in S52 immediately after receiving compressed print data (Yes in S52), and if the printer engine unit 29 is in the warm-up completed state, the normal distribution ratio of storage capacity is specified for the data storage unit 18 (S56). After the same process as in S35 of FIG. 4, the printing process is terminated.

As described above, since at the time of warm-up, the storage capacity of the compressed print data storage unit 25 is increased by modifying each segment of data storage capacity and during the warm-up, compressed print data is received and accumulated in the compressed print data storage unit 25, printing can be executed using the compressed print data stored in the compressed print data storage unit 25 even when its transfer performance is poor. Accordingly, printing speed can be improved.

### The Fourth Preferred Embodiment

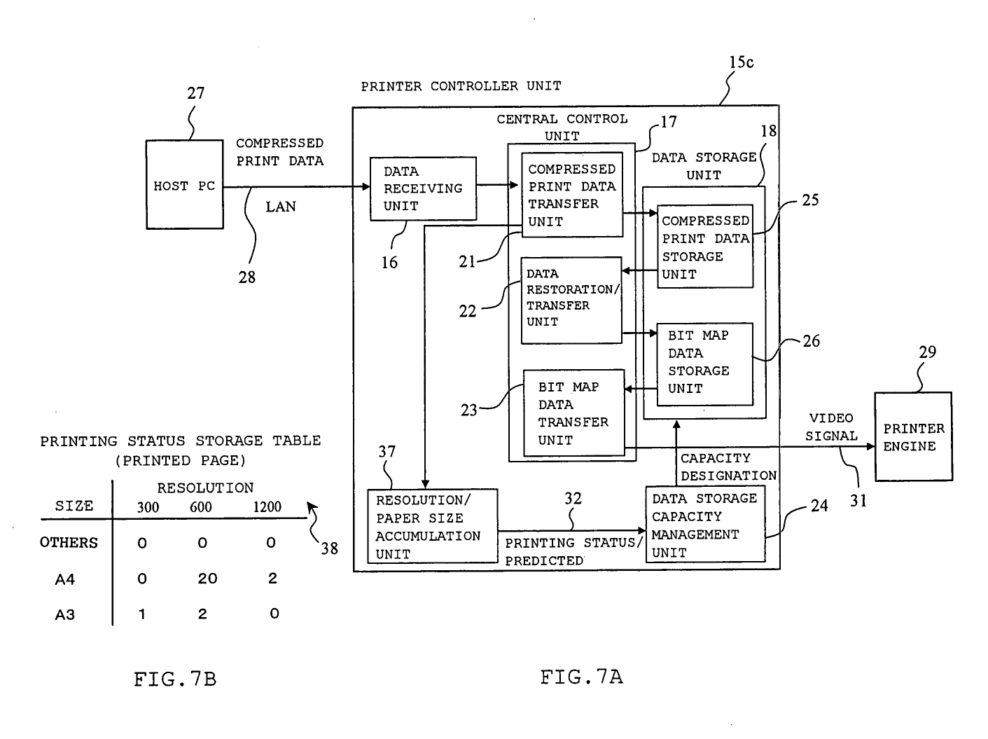

FIG. 7A shows the configuration of the printer controller unit of a printer in the fourth preferred embodiment, and FIG. 7B shows an example of the data of the printing status storage table. In FIG. 7A, the same reference numerals as in FIG. 2 are attached to components that also appear in FIG. 2.

As shown in FIG. 7A, in this preferred embodiment, a printer controller unit 15c comprises a resolution/paper size accumulation unit 37 instead of the warm-up status determination unit 35 shown in FIG. 5. This resolution/paper size accumulation unit 37 stores a print status storage table 38 shown in FIG. 7B. This printing status storage table accumulates and stores the print resolution and paper size frequencies of previous print targets.

In the example shown in FIG. 7B, in the printing status storage table 38, its columns indicate resolution, such as “300 (dots)”, “600” and “1,200”, and its rows indicate paper size, such as “Miscellaneous”, “A4” and “A3”.

In the example shown in FIG. 7B, if the resolution is 600 dots and paper size is A4, a numeric value corresponding to these in the table takes the maximum numeric value “20”. This indicates the frequency of use of the size A4 at a resolution of 600 dots, a paper size of A4 is most used and a resolution of 600 dots is most used.

The resolution/paper size accumulation unit 37 instructs the data storage capacity management unit 24 to modify the storage capacity of each of the compressed print data storage unit 25 and bitmap data storage unit 26 to a storage capacity corresponding to the predicted print status based on the most frequently used print status of the data in the printing status storage table 38.

Generally when a printing device is installed at a site, the printing device is requested to print specific fixed documents according to the fairly fixed usage of users.

The selection of print resolution and paper size gradually converge to a specific print status according to an installation site. For example, if a printing device is installed in an accounting section or the like, the selection of print resolution and paper size will gradually converge to the print status of slips. If it is installed in a sales department, it will gradually converge to the print status of agreements. If it is installed in the teachers' room of a kindergarten, an elementary school or the like, it will gradually converge to the print status of fairly small-sized paper, such as B5. If it is installed in a design department, it will gradually converge to the print status of fairly large-sized paper, such as A3 or larger at a high resolution.

Therefore, in this preferred embodiment, the resolution and paper size of previous print targets are stored in the printing status storage table 38 shown in FIG. 7B and is managed. Thus the storage capacity of each of the compressed print data storage unit 25 and bitmap data storage unit 26 are pre-determined and each segment of the determined storage capacity is set in each of the storage units as default values.

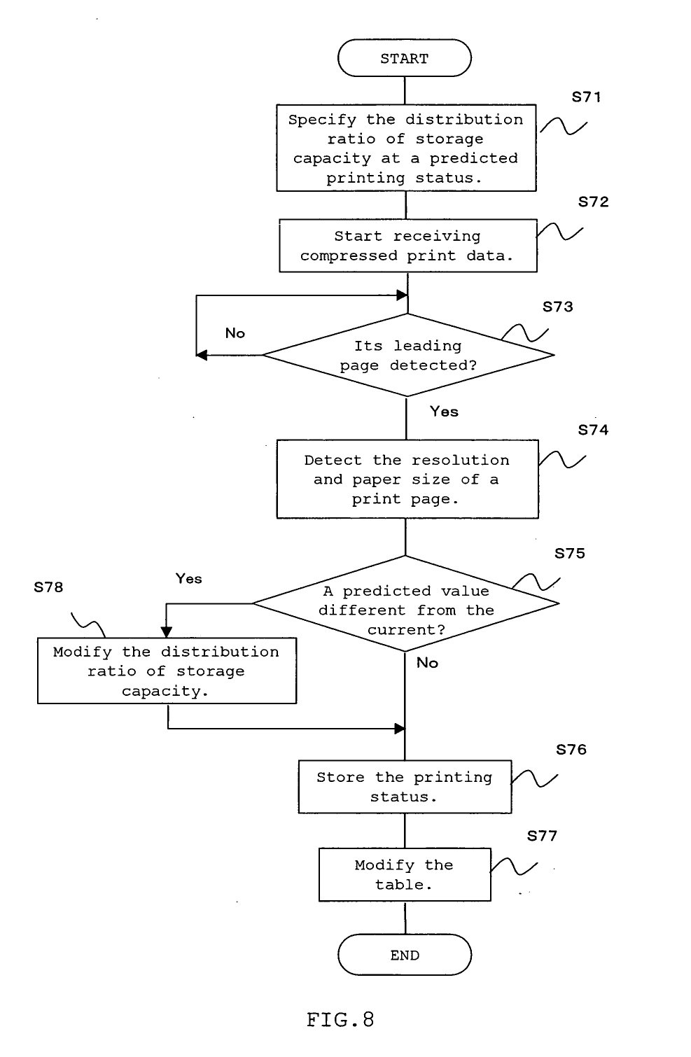

FIG. 8 is a flowchart showing the printing process of the printer controller 15c in the fourth preferred embodiment. In FIG. 8, when starting printing, the central control unit 17 firstly specifies storage capacity of a predicted print status (S71).

In this process, the central control unit 17 distributes storage capacity between the compressed print data storage unit 25 and the bitmap data storage unit 26 in such a way that they correspond to the most frequently used print status, for example, in the example shown in FIG. 7B, a condition that resolution and paper size are 600 dots and A4, respectively, which is represented by the maximum numeric value “20”, is met, based on the print status storage table 38, by the resolution/paper size accumulation unit 38.

For example, according to table 34 indicating the relationship between resolution, paper size and the capacity of a storage unit shown in FIG. 3B, if the resolution and paper size are 600 dots and A4, respectively, storage capacity is distributed between the compressed print data storage unit 25 and bitmap data storage unit 26 at a ratio of “8:2”. Thus, storage capacity can be optimally distributed for the case where resolution and paper size are 600 dots and A4, respectively.

Processes in subsequent steps S72, S73 and S74 are the same as those in S31, S32 and S33, respectively, shown in FIG. 4. However, in this preferred embodiment, when in the process in step S74, the resolution and paper size of a page to print is detected, the information is transferred to the resolution/paper size accumulation unit 37.

The resolution/paper size accumulation unit 37 determines whether the transferred current printing status information is different from the resolution and paper size predicted in S71 (S75).

If the transferred current printing status information coincides with the predicted resolution and paper size (No in S75), the current resolution and paper size of the printing status information are stored (S76), and the print status storage table 38 is updated (S77).

In this case, the frequency of print “20” for the case where resolution and paper size are 600 dots and A4, respectively, is updated to “21”.

Then, the data storage capacity management unit 24 is notified that the current distribution ratio of storage capacity should be maintained, (not shown in FIG. 8), by the resolution/paper size accumulation unit 37. The same process as in S35 of FIG. 4 is performed and the printing process terminates.

If in the determination of S75, the transferred current printing status information differs from the predicted resolution and paper size (Yes in S75), the resolution/paper size accumulation unit 37 modifies the storage capacity of each of the compressed print data storage unit 25 and bitmap data storage unit 26 in such a way that the transferred current print status information coincides with the predicted resolution and paper size, by referring to the management table 34 shown in FIG. 3 (S78).

Then, the current resolution and paper size are stored (S76) and the printing status storage table 38 is updated (S77).

In this case, the data in the data field of the print status storage table 38, corresponding to the combination of the current resolution and paper size that are different from the respective predicted values is incremented by “1” and is updated.

Then, after the resolution/paper size accumulation unit 37 instructs the data storage capacity management unit 24 to modify the distribution ratio of the storage capacity, which is not shown in FIG. 8, the same process as in S35 of FIG. 4 is performed, and the printing process terminates.

Since the storage capacity of each of the compressed print data storage and bitmap data storage units is optimally allocated, based on the previous usage of a user at the beginning of printing, a user can always use a printing device with his/her optimal conditions, and accordingly, printing efficiency can be improved.

Alternatively, a case where printed contents are greatly modified can be taken into consideration, and a mechanism for initializing the data contents of the printing status storage table 38 in the resolution/paper size accumulation unit 37 according to the instructions of a user can be provided.

### The Fifth Preferred Embodiment

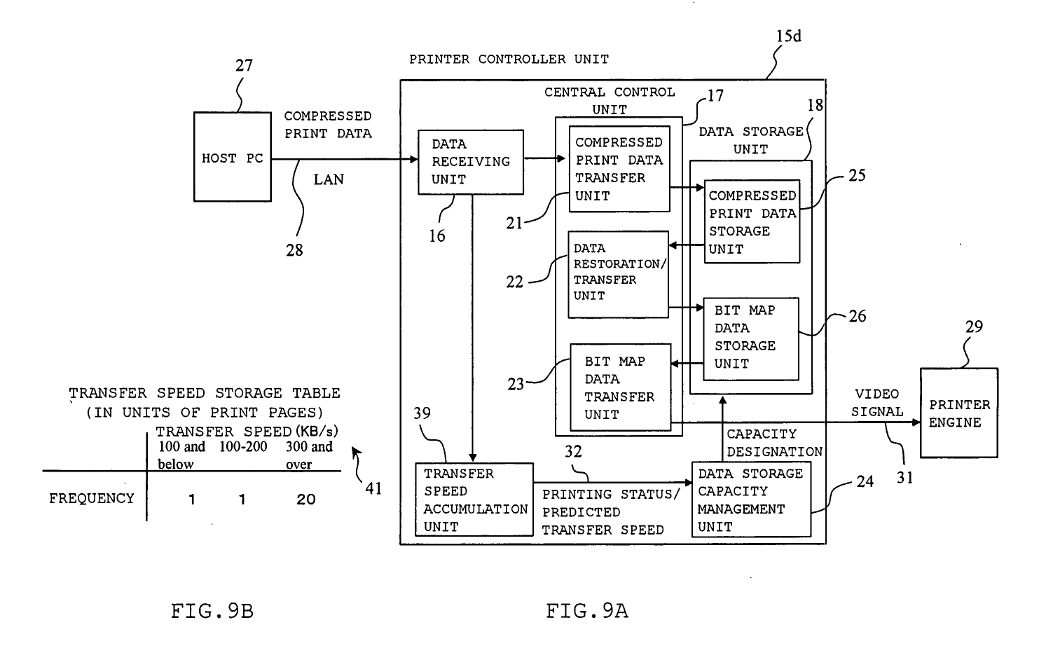

FIG. 9A shows the configuration of the printer controller unit of a printer in the fifth preferred embodiment, and FIG. 9B shows an example of the data of the printing speed storage table. In FIG. 9A, the same reference numerals as in FIG. 2 are attached to the components that also appear in FIG. 2.

As shown in FIG. 9A, in this preferred embodiment, a printer controller unit 15d comprises a transfer speed accumulation unit 39 instead of the resolution/paper size accumulation unit 37 shown in FIG. 7.

Generally, when a printing device is installed at a site, the respective environments of a network connected to the printing device and host equipment converge to a specific status (performance). For example, if the transfer speed of a network is high, compressed print data is always transferred. In this case, the storage capacity of the compressed print data storage unit 25 is reduced and the storage capacity of the bitmap data storage unit 26 is increased up to two pages or more to prevent the occurrence of decompression wait. Thus, printing performance can be improved.

In this preferred embodiment, attention is paid to this fact, and the transfer speed accumulation unit 39 measures the data transfer speed of each page. Then, the average transfer speed per page of data previously printed by the printing device is stored in the transfer speed storage table 41 and is managed.

In the example shown in FIG. 9B, in the transfer speed storage table 41, transfer speeds per page (KB/s), such as 100 or less”, “100˜200” and “300 or more”, are shown in the top row, and under it, the previous print frequencies, such as “1”, “1” and “20”, at each respective transfer speed. This indicates that most of print targets previously printed were printed at the transfer speed of 300 KB/s per page or higher.

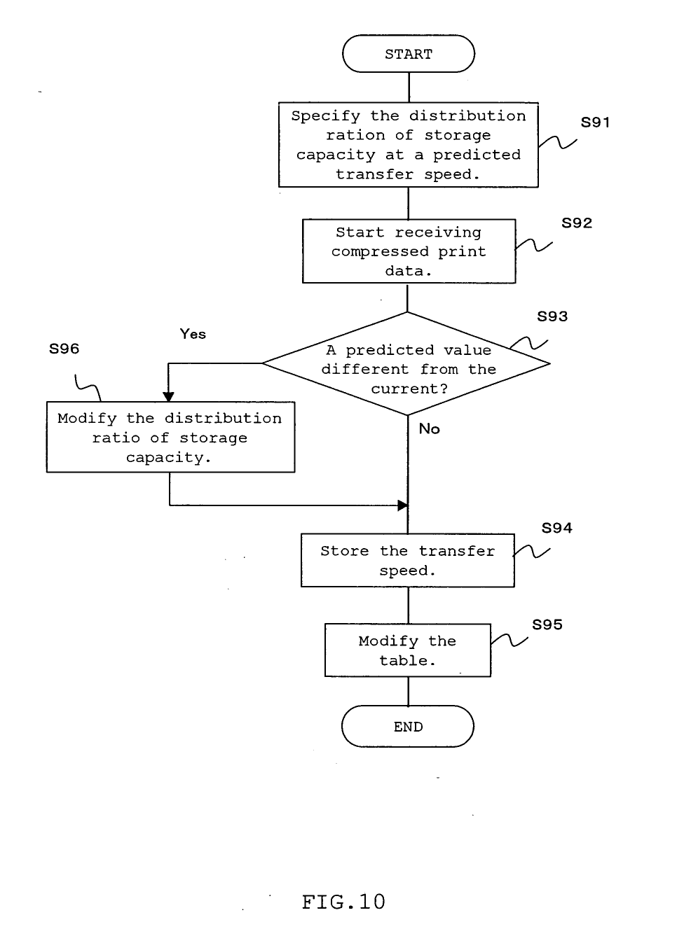

FIG. 10 is a flowchart showing the printing process of the printer controller 15d in the fifth preferred embodiment. In FIG. 10, when starting printing, the central control 7, firstly, specifies storage capacity corresponding to a predicted transfer speed (S91).

In this process, the central control unit 17 distributes storage capacity between the compressed print data storage unit 25 and bitmap data storage unit 26 so that the transfer speed per page previously used most frequently, that is, in the example shown in FIG. 9B, a transfer speed of 300 KB/s indicated by the maximum numeric value “20” can be met, by the transfer speed accumulation unit 39, according to the transfer speed storage table 41 shown in FIG. 9B.

The printing device in this preferred embodiment presumes that if the transfer speed is 300 KB/s, compressed print data is always transferred via the network. Therefore, for example, in this case, the storage capacity of the compressed print data storage unit 25 is reduced, and storage capacity for two pages or more are allocated to the bitmap data storage unit 26. Thus, the occurrence of decompression wait can be prevented, and accordingly, printing performance can be improved.

As the data receiving unit 16 starts to receive compressed print data (S92), the transfer speed accumulation unit 39 measures the transfer speed at which the received compressed print data is transferred via the local network 28, and determines whether the transfer speed predicted in S91 differs from the current transfer speed (S93).

If the predicted transfer speed coincides with the current transfer speed (No in S93), the current transfer speed is stored (S94), and the data of the transfer speed storage table 41 is updated (S95).

In this case, since the predicted transfer speed and the current transfer speed are the same, the frequency of print “20” corresponding to 300 dots or more, which was the predicted value is updated to “21”.

Then, after the transfer speed accumulation unit 39 instructs the data storage capacity management unit 24 to maintain the current distribution ratio of storage capacity, not shown in FIG. 10, the same process as in S35 of FIG. 4 is performed and the printing process terminates.

If in the determination of S93, the predicted transfer speed differs from the current transfer speed (Yes in S93), storage capacity can be distributed between the compressed print data storage unit 25 and bitmap data storage unit 26 in such a way as to optimally meet the current transfer speed (S96), and the current transfer speed is stored (S94). Furthermore, the transfer speed storage table 41 is updated (S95).

In this case, the data in the data field of the transfer speed storage table 41, corresponding to the current transfer speed, which is different from the default value of 300 dots or more is incremented by “1” and is updated.

Then, after the transfer speed accumulation unit 39 instructs the data storage capacity management unit 24 to modify the current distribution ratio of storage capacity, not shown in FIG. 10, the same process as in S35 of FIG. 4 is performed and the printing process terminates.

Thus, an optimal printing device can be provided in a state where the respective environments of a network and host equipment are fixed, by storing and managing the average transfer speed per page of data previously printed at average transfer speed by the printing device and modifying the distribution ratio between the compressed print data storage unit and bitmap data storage unit according to the result of this transfer speed.

If the respective transfer speeds of the network and host equipment are high, the occurrence of decompression wait can be prevented by reducing the storage capacity of the compressed print data storage unit in correspondence with the speed and increasing the storage capacity of the bitmap data storage unit up to two pages or more. Thus, printing performance can be improved.

Alternatively, a case where printed contents are greatly modified can be taken into consideration, and a mechanism for initializing the data contents of the transfer speed storage table 41 in the transfer speed accumulation unit 39 according to the instructions of a user can be provided.

As described above in detail, according to the present invention, each data storage area can be managed so as to be efficiently used for each segment of print target data by dynamically modifying the distribution ratio of storage capacity between the compressed print data storage unit and bitmap data storage unit in a printing device, according to resolution, paper size, a status at the time of device warm-up, the previous usage conditions of a user, environmental conditions at the time of printing, such as the respective transfer performance of a network and host equipment, and the like.

As a result, even if the receiving speed of a printing device is low, even if the transfer performance in the printing device is poor, even if the usage conditions of a user differs from the default set in the printing device, even if the respective transfer speeds of a network and host equipment are high or the like, printing can be executed using the maximum printing performance of the printing device. Therefore, printing efficiency can be improved.

Since the capacity of expensive memory can be used without waste, the present invention greatly contributes to the effective use of resources.

As described above, the printing device of the present invention can receive compressed print data from host equipment of a printer without its own fonts without the need to expand the memory capacity, and can always print efficiently without wasting memory capacity. The present invention can be used in all industries using a printer without its own font, for receiving compressed print data and printing it.

1. A printer control device, comprising:
a compressed print data receiving unit for receiving compressed print data;
a compressed print data storage unit for storing the received compressed print data in compressed print data storage area in units of pages;
a bitmap data storage unit for restoring the compressed print data stored in the compressed print data storage unit to bitmap data in units of pages and storing the restored bitmap data in a bit map data storage area; and
a storage capacity management unit for modifying the distribution ratio of storage capacity between the compressed print data storage unit and the bitmap data storage unit, according to a print status of a printing device.

2. The printer control device according to claim 1, wherein
said storage capacity management unit modifies a distribution ratio of storage capacity between said compressed print data storage unit and said bitmap data storage unit, based on print resolution and paper size of a print target of the bitmap data restored in units of pages.

3. The printer control device according to claim 1, wherein
said storage capacity management unit modifies a distribution ratio of storage capacity between said compressed print data storage unit and said bitmap data storage unit, based on a determination result of a warm-up status determination unit for managing a warm-up status of the printing device.

4. The printer control device according to claim 1, wherein
said storage capacity management unit modifies a distribution ratio of storage capacity between said compressed print data storage unit and said bitmap data storage unit, based on a frequency of use of print resolution and paper size of print targets previously printed by the printing device.

5. The printer control device according to claim 1, wherein
said storage capacity management unit modifies in advance a distribution ratio of storage capacity between said compressed print data storage unit and said bitmap data storage unit, based on receiving speed of data previously printed by the printing device.
